(19) United States
(12) Patent Application Publication
(10) Pub. No.: US 2006/0095719 A1
(43) Pub. Date: May 4, 2006

(54) Microcontroller having partial-twin structure

(76) Inventor: Chuei-Liang Tsai, Yonghe (TW)

Correspondence Address: Jenny W. Chen;Baker & McKenzie, 29FI., 805 Third Avenue, New York, NY, 10022, US

(21) Appl. No.: 10/943,834

(22) Filed: Sep. 17, 2004

(51) Int. Cl. G06F 15/00

(52) U.S. Cl. 712/34

(57) ABSTRACT

A partial twin microprocessor structure which can run multiple tasks in parallel is disclosed. The partial-twin microprocessor structure comprises a first set of processing units to be shared by at least two tasks running in parallel, a plurality of program counters to store a plurality of program addresses for different tasks, an address selection logic to output a program address to the first set of processing units, and a plurality of stack memories. The partial twin microprocessor structure offers a flexible, powerful, and low cost platform for firmware development.

### BACKGROUND OF THE INVENTION

1. Field of the Invention

This invention relates in general to the field of microcontroller, and more particularly to a structure and method of executing multiple tasks in parallel with a partial twin microcontroller.

2. Description of the Related Art

A conventional microcontroller usually has several major units, such as random access memory (RAM) 102, read only memory (ROM) 104, program counter 106, stack 108, instruction decoder 110, arithmetic logic unit (ALU) 112, status register 114, accumulator 116 and other control logic 118, as shown in FIG. 1.

This type of microcontroller must execute the instructions sequentially, step by step or routine by routine. If a programmer would like to do two routine jobs with the conventional microcontroller, he has to finish one routine and then run another routine. However, the need of running certain specific applications, such as key scanning, the interface of communication, etc., requires running two routine jobs in parallel during some clock cycles. This type of situations is more difficult for a programmer to arrange which routine should be done first and which routine should be held until the other routine is finished.

Referring now to FIG. 2, it is illustrating how the conventional microcontroller uses the interrupt function to designate the routine with a higher priority to run first. Because the microcontroller can only do one routine at a time, interrupt sometimes is necessary for switching between one routine and a second routine while those two routines are run for a certain period of time. However, too many jumps caused by interrupts will make a microcontroller program unstable, causing the program to crash easily and is very difficult to debug due to the randomness. If interrupt is not used, the programmer has to setup checkpoints to see if it's the right time to change the desired routine to be executed. This latter method will always waste some percentage of microprocessor running time to do this extra job, and it is troublesome for a firmware engineer to decide where the checkpoints should be put.

Referring back to FIG. 2 again, if we can let the sequential run become parallel run, most of the difficulties of two routines execution will be eliminated for a programmer. Two ways a program can run in parallel are a system with two identical microcontrollers and a system with microcontrollers having a multi-tasking feature. Such systems are generally shown in FIG. 3.

If the engineer adopts the system with dual microcontrollers, there will be more firmware jobs such as handshake or the protocol of communication in the interface between these two microcontrollers. In addition to the application with dual microcontroller system, a firmware programmer needs a microcontroller that can run two routine jobs simultaneously; that is, a microcontroller or microprocessor with multi-tasking feature. Both the application system with dual microcontroller and the microcontroller with multi-tasking, however, are much more expensive than a system with just a single microcontroller. For cost considerations, dual microcontroller and microcontroller with multi-tasking feature are still not feasible.

Therefore, there is still a need for a microcontroller structure which can offer a flexible and powerful platform with pseudo bi-microprocessor or multi-tasking features.

### SUMMARY OF THE INVENTION

The invention disclosed herein is directed to a partial twin microprocessor structure which can run multiple tasks in parallel. The partial twin microprocessor structure according to the present invention offers a flexible, powerful, and low cost platform for firmware development.

One aspect of the present invention contemplates a task selection apparatus for a partial-twin microcontroller device. The task selection apparatus for the partial-twin microprocessor structure includes a plurality of program counters to store a plurality of program addresses, and an address selection logic to output a program address.

Another aspect the present invention provides a partial-twin microprocessor structure. The partial-twin microprocessor structure comprises a first set of processing units to be shared by at least two tasks running in parallel, a plurality of program counters to store a plurality of program addresses for different tasks, an address selection logic to output a program address to the first set of processing units, and a plurality of stack memories.

Yet another aspect of the present invention provides a method of executing multiple tasks in parallel comprising the steps of providing a plurality of program addresses into a partial-twin microprocessor, selecting a program address to be inputted into a program memory, and loading a program from the program memory.

### BRIEF DESCRIPTION OF THE DRAWINGS

The accompanying drawings are included to provide a further understanding of the present invention, and are incorporated in and constitute a part of this description. The drawings illustrate embodiments of the present invention, and together with the description, serve to explain the principles of the present invention. There is shown:

FIG. 1 illustrates a block diagram of a conventional microcontroller structure;

FIG. 2 illustrates how a conventional microcontroller uses the interrupt function to execute tasks in strict sequential order;

FIG. 3 illustrates how a conventional microcontroller runs two tasks in parallel;

FIG. 4 illustrates a block diagram of a partial-twin microcontroller structure according one embodiment of the present invention;

FIG. 5 illustrates a schematic diagram of a program counter according to a preferred embodiment of the present invention;

FIG. 6 shows a waveform associated with a program counter according to an embodiment of the present invention;

FIG. 7 illustrates a schematic diagram of a stack according to a preferred embodiment of the present invention;

FIG. 8 illustrates a schematic diagram of a stack according to another embodiment of the present invention;

FIG. 9 shows a waveform associated with a program counter while disabling a partial-twin feature according to an embodiment of the present invention;

FIG. 10 shows a waveform associated with a program counter while disabling a double-frequency feature according to an embodiment of the present invention;

FIG. 11 shows a waveform associated with a program counter while enabling both a partial-twin and double-frequency features according to an embodiment of the present invention; and

FIG. 12 shows a waveform associated with a program counter while the duty cycle is 75% according to an embodiment of the present invention.

### DESCRIPTION OF THE PREFERRED EMBODIMENTS

The invention disclosed herein is directed to a partial twin microprocessor structure which can run multiple tasks in parallel. The partial twin microprocessor structure according to the present invention offers a flexible, powerful, and low cost platform for firmware development. In the following description, numerous details are set forth in order to provide a thorough understanding of the present invention. It will be appreciated by one skilled in the art that variations of these specific details are possible while still achieving the results of the present invention. In other instances, well-known backgrounds are not described in detail in order not to unnecessarily obscure the present invention.

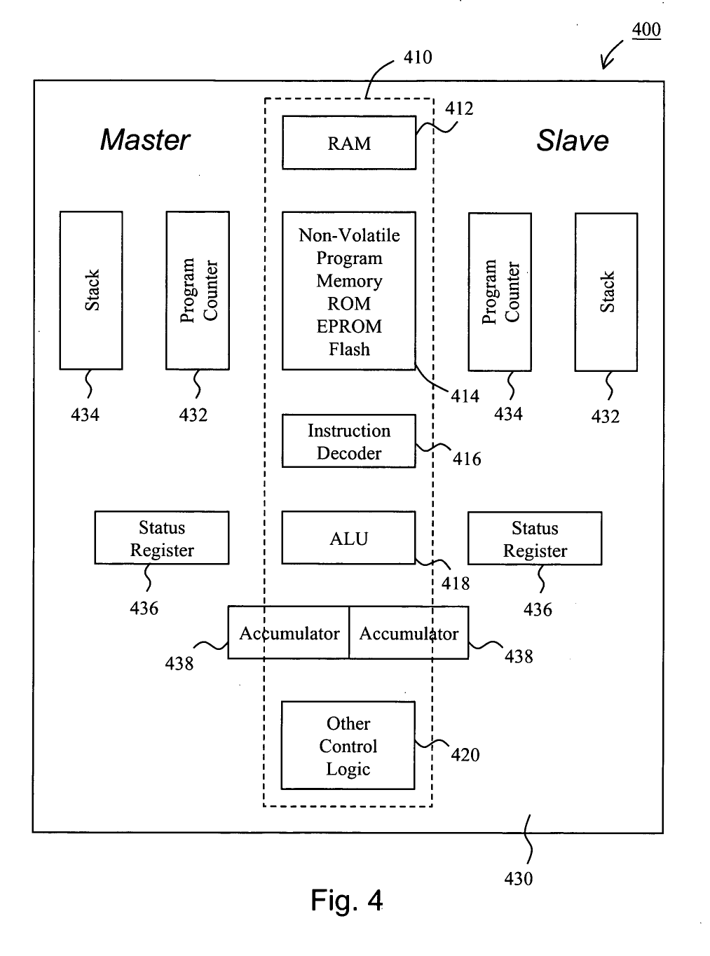

Referring now to FIG. 4, there is shown a schematic diagram of a partial twin microprocessor structure according to a preferred embodiment of the present invention. The twin microprocessor structure 400 comprises a first set 410 of processing units to be shared by at least two tasks running in parallel, and a second set 430 of processing units, to be dedicated in one task when running at least two tasks in parallel.

In one embodiment, the first set 410 of processing units comprises a random access memory (RAM) 412, a read only memory (ROM) 414, an instruction decoder 416, an arithmetic logic unit (ALU) 418 and other control logics 420.

In one embodiment, the second set 430 of processing units comprises a pair of program counters 432, stacks 434, status registers 436, and accumulators 438. Under the exemplary structure of Partial-Twin, several blocks such as the Program counter 432, Stack 434, Status register 436 and Accumulator 438, should have their twins for simulating BI-microcontroller by time-division method. For easy understanding purpose, we define the “first” twin as Master and call the “second” twin as Slave. Although the microcontroller with Partial-Twin structure can run only one instruction at a time, it can be regarded as the one which can run the two routine jobs of Master and Slave at the same time by insensible processing time distribution from the firmware programmer's point of view.

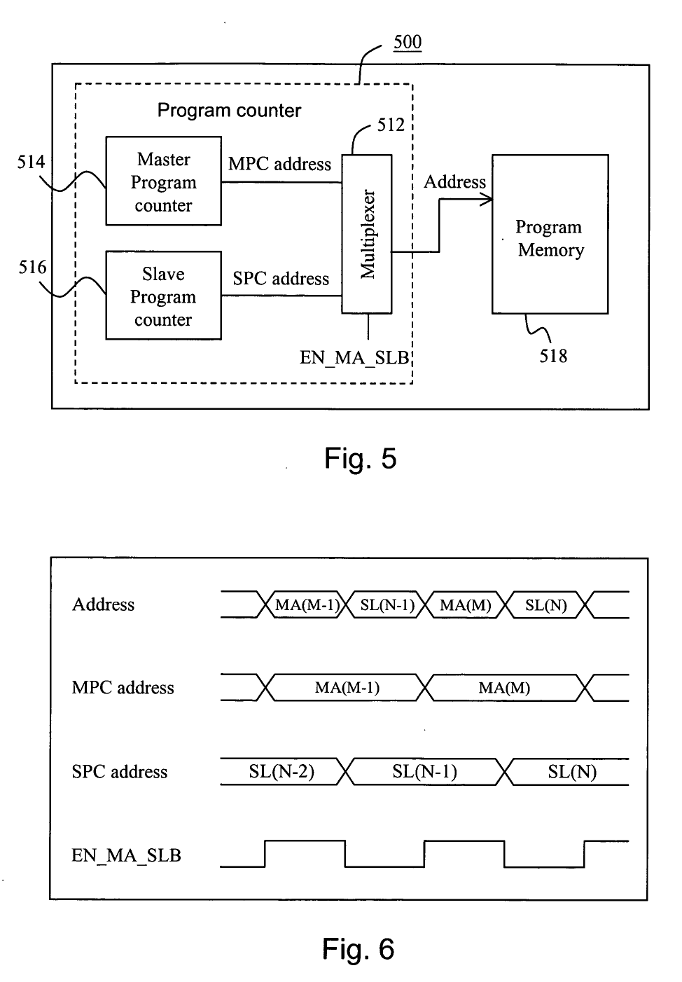

Referring now to FIG. 5, there is shown a schematic diagram of a program counter according to a preferred embodiment of the present invention. In one embodiment, the Program Counter 500 includes a multiplexer 512, a Master program counter (MPC) 514 and a Slave program counter (SPC) 516 as shown in FIG. 5. The MPC 514 and SPC 516 share only one program memory 518. The addresses of MPC and SPC are multiplexed and send an selected address signal Address (i.e., the multiplexed result) is sent to the Program memory 518.

One control signal EN_MA_SLB is employed to control the switching between MPC and SPC because of the time sharing of Program memory. FIG. 6 is the waveform associated with the program counters 514 and 516. MPC address is chosen as the address of Program counter while EN_MA_SLB goes high and then SPC address is chosen while EN_MA_SLB is low. Under this structure, one program memory can be run separately and independently by Master and Slave. There won't be any conflict even if Master and Slave are running the same program, so the Program memory 518 can be shared peacefully by the Master and Slave.

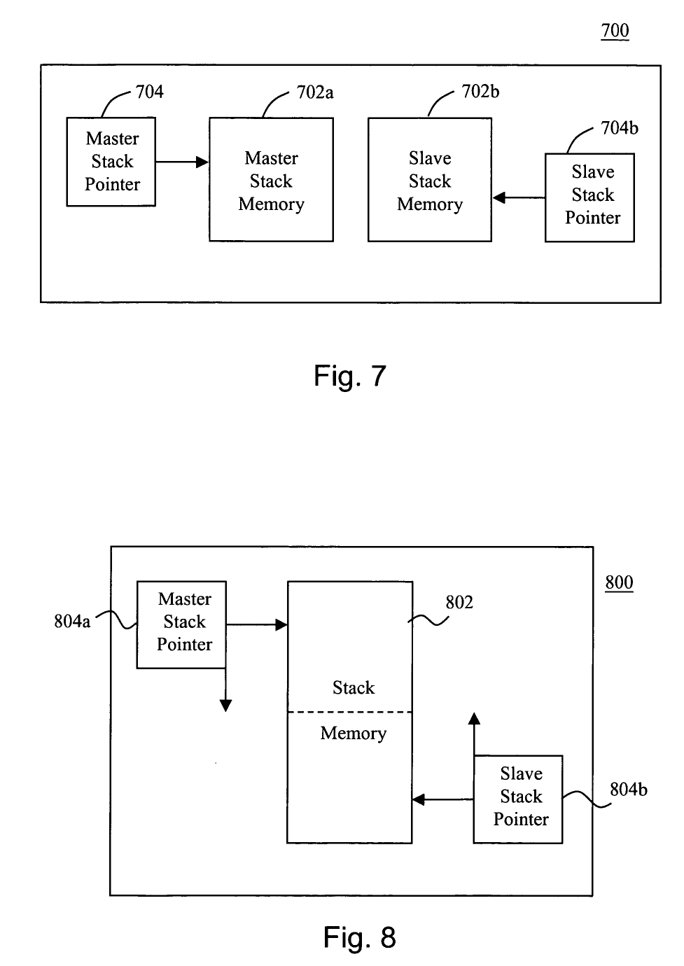

In one embodiment, a stack 700 includes a pair of stack memories 702 and stack pointers 704 as shown in FIG. 7. The Stack memory 702 stores the return address while the program calls the subroutine or interrupt occurs. Because the microcontroller with partial-twin structure has two different Program counters, Stack memory 702 should also has two parts, one for Master and the other one for Slave, as the same as Program Counter. The stack levels of Master and Slave can be different depending on the real application. In another embodiment, a stack 800 may include only one stack memory 802 and a pair of stack pointers 804a, 804b as shown in FIG. 8. The Master Stack and Slave Stack share the same Stack memory and have their own Stack pointers. The Master Stack pointer and the Slave Stack pointer go from the opposite side in the opposite direction. The design of Stack Memory in FIG. 8 may be more flexible than the design in FIG. 7. Both the memory level of Master Stack and the memory level of Slave Stack are floating and thus can be freely untilized by Master and/or Slave. The overflow of Stack occurs only when the depth of Master Stack used plus the depth of Slave Stack used are greater than the total depth of the Stack memory.

Additionally, the Partial-Twin microcontroller of the present invention may include some additional control signals to make it more powerful and flexible.

a) The Control Signal of Enabling “Partial-Twin”

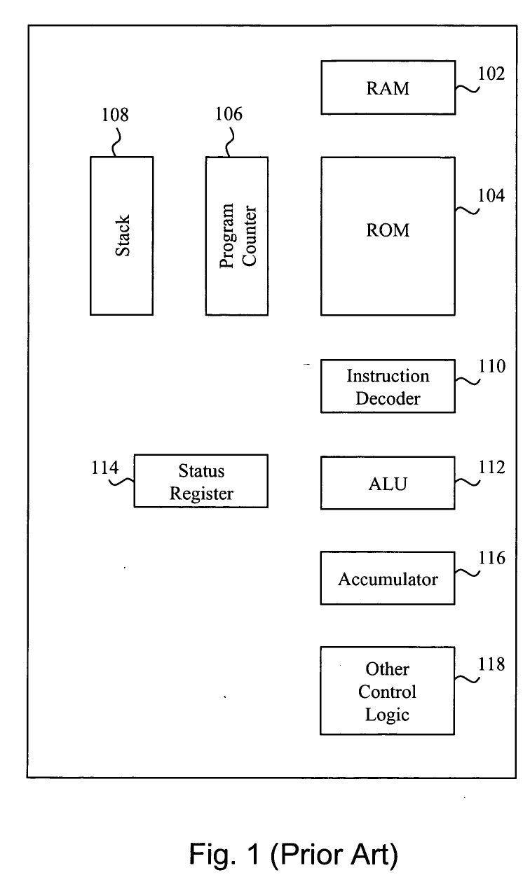

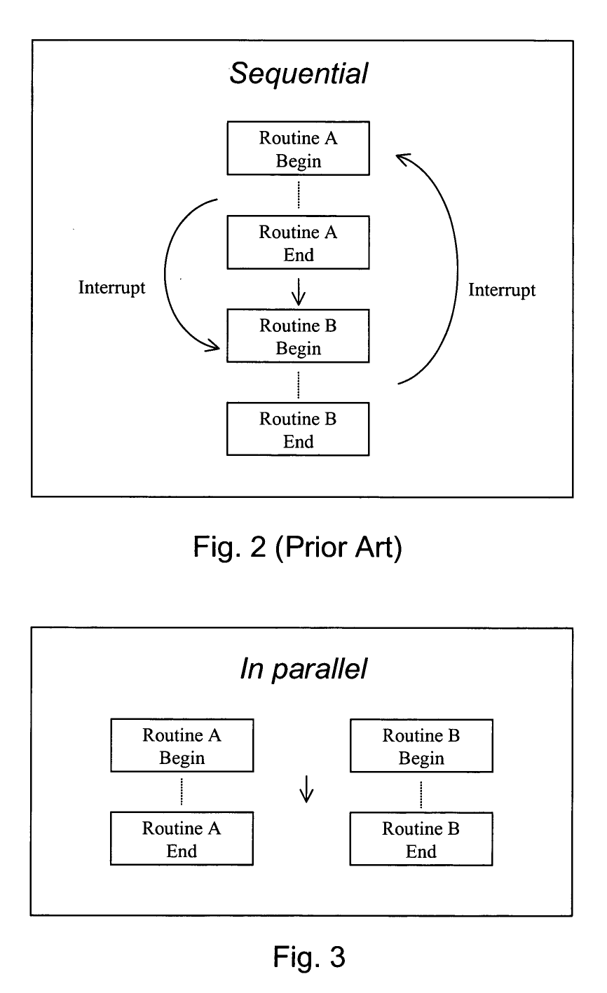

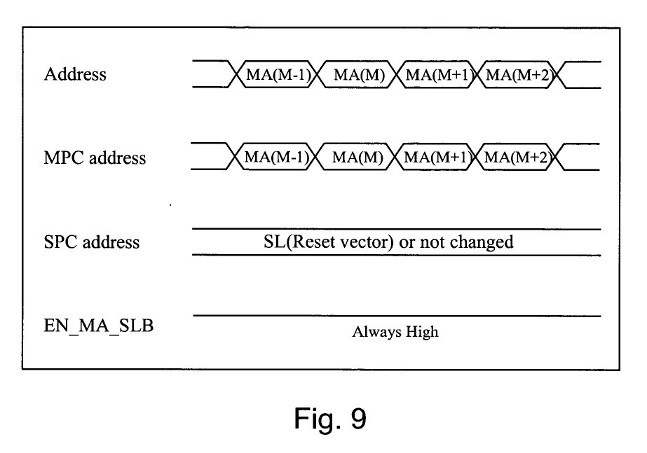

In one preferred embodiment, a control signal EN_PT can enable or disable the ability to run the Master program and Slave program simultaneously for the Partial-Twin microcontroller of the present invention. If a programmer wants to run the Master program only, the feature can be turned off easily by changing the status of the control signal EN_PT. For example, the control signal EN_PT can be driven by the bit of some control register or alternatively the special instruction designated for the purpose. That is, when the Partial-Twin microcontroller turns off the feature, it becomes an ordinary conventional microcontroller as shown in FIGS. 1 and 2. Referring now to FIG. 9, it is a timing diagram illustrating the waveform associated with the program counter while disabling the Partial-Twin feature. When it turns on the EN-PT control signal, it becomes a powerful microcontroller illustrated by FIGS. 4 and 6 described before.

Because there could be only one ALU, program memory and instruction decoder shared by the tasks running in parallel, enabling the Slave part will reduce the number of MIPS (million instructions per second ) to half compared with disabling the Slave part due to time division. We can observe the difference between FIG. 6 and FIG. 9. It's up to a firmware programmer to turn on or off the Slave at any time depending on the situation and the need.

b) The Control Signal of Enabling “Double-Frequency”

As described in previous section “a”, a control signal EN_PT can enable or disable the ability of running Master program and Slave program simultaneously for the Partial-Twin microcontroller of the present invention. However, some applications need the same speed (or MIPS ) regardless of Partial Twin enabled or disabled. In other situations, the firmware programmer may not want to worry about the change of execution speed under different situations. Therefore, in yet another preferred embodiment, the microcontroller with the structure of Partial-Twin can have another control signal to determine whether it runs at the normal or double speed. A “Double frequency” signal EN_DF can be added to cancel out the phenomenon of the division by two i.e. decreased MIPs due to the fact that some resources are shared by both Master and Slave in order to maintain the same MIPS in any situation. The circuit of doubling frequency can be designed by the scheme of “Double-Edge Trigger.” In other words, each edge of the clock cycle would tragger a response or action.

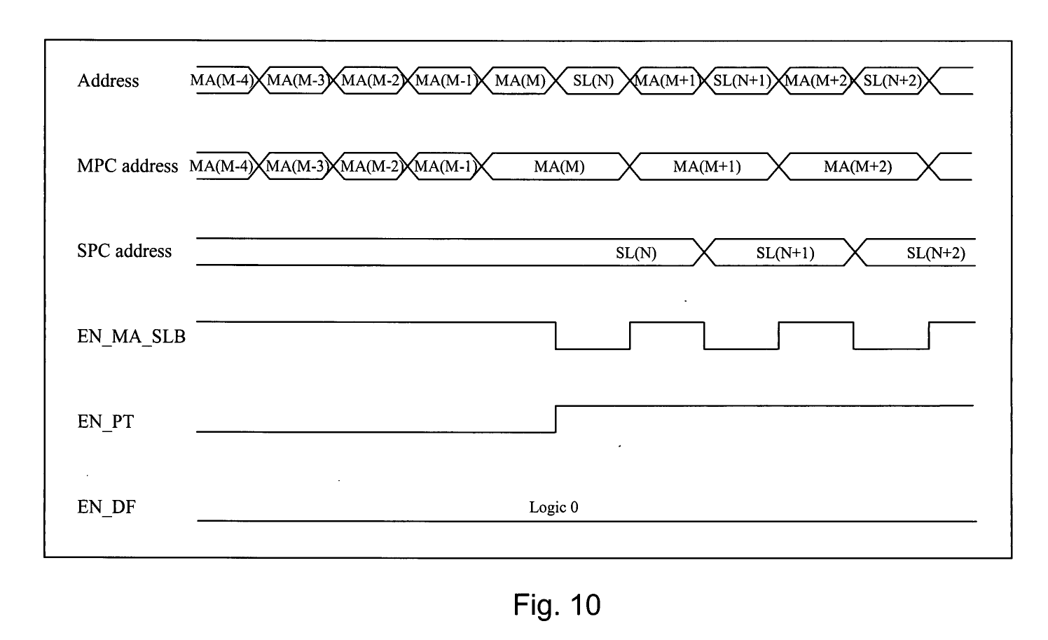

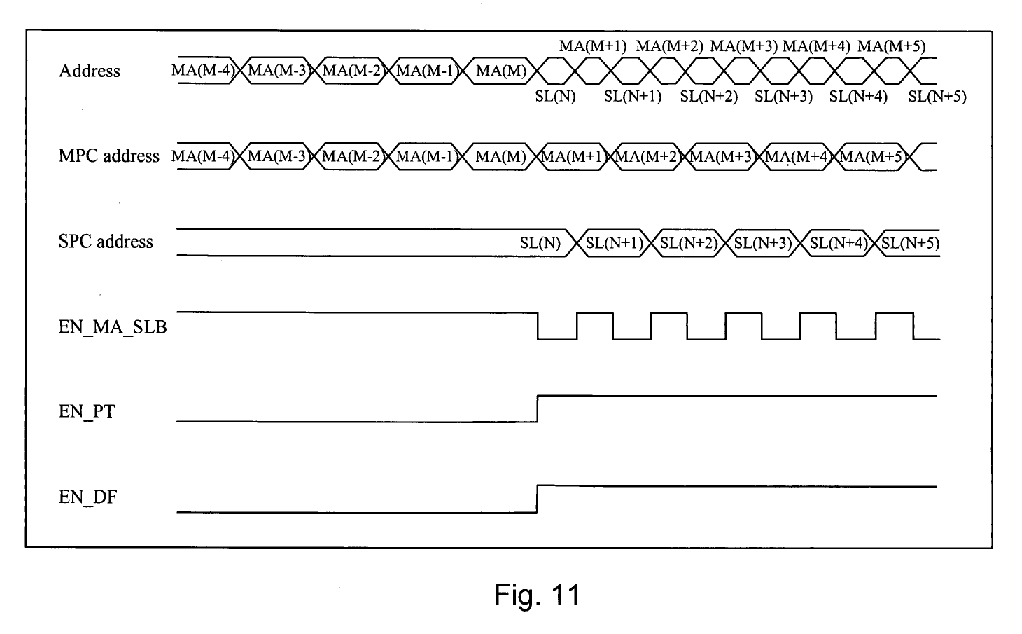

Compare FIG. 10 with FIG. 11 which are the timing diagrams illustrating the waveforms associated with the Program counter while disabling and enabling double frequency feature, respectively, according to one embodiment of the present invention. These waveforms illustrate the advantages of this Double frequency feature.

In FIG. 10, the speed of the instruction execution for each side of Master and Slave is halved while enabling the feature of Partial-Twin. When the features of “Double frequency” and Partial Twin are employed at the same time, the speed of the instruction execution for both Master side and Slave side is all the same as the speed before enabling this powerful function. That is, the microcontroller can maintain the same running instruction speed regardless of whether the Partial-Twin feature is enabled or not.

c) The Duty Cycle of EN_MA_SLB

In yet another preferred embodiment, control signal EN_MA_SLB can be further implemented to switch the usage of Master and Slave more efficiently. The above mentioned examples are all using the duty cycle of EN_MA_SLB 50%, that is, Master part and Slave part occupy 50% of execution time each. There are some applications, however, where a slower routine is combined with a faster one. For example, the application has to handle a high speed calculation and a low speed I/O interface simultaneously. This situation requires that the duty cycle be adaptive in order to achieve higher efficiency of the running time. According to one embodiment of the present invention, the microcontroller with a control signal EN_MA_SLB to control the duty cycle is much more efficient than a fixed duty cycle.

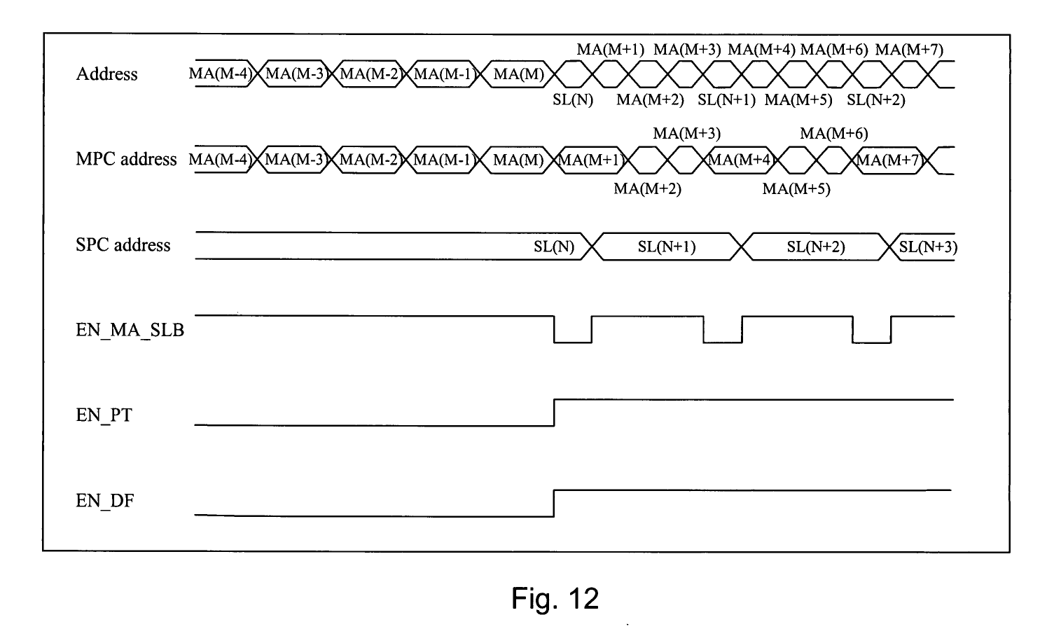

FIG. 12 is an example in which the duty cycle of EN_MA_SLB is 75%. That is, the microcontroller performs one instruction of a routine of Slave for every three Master instructions so that Master program running speed is three times higher than Slave running speed. Therefore, Master can be customized to run applications that require a higher speed while Slave is handling lower speed applications at the same time. The benefits of a flexible duty cycle with EN_MA_SLB are thus numerous.

The main object of the Partial-Twin structure according to the present invention is to provide a simple and efficient structure by duplicating a portion of the major functional blocks or units in a microcontroller in order to run multiple tasks in parallel. Of course, we can duplicate more or less than four blocks as described in the embodiment to obtain an ever more flexible platform for the microcontroller application at the cost of increasing the chip size. For example, if RAM is duplicated, the address of RAM can be possessed independently by Master and Slave. So Master and Slave can run the same routine program using identical RAM addresses at the same time without any conflict. The need of the application that the microcontroller is designed for along with chip size and cost should dictate whether the blocks that should be duplicated. This determination although is part of this invention should be readily apparent to one skilled in the art and for the sake of brievity, is not further discussed in even greater details in this section.

The Partial-Twin structure according to the present invention offers at least the following advantages compared with a conventional microprocessor structure of the prior arts:

1. It can offer a platform where two routine jobs can be executed at the same time.

That way, a firmware programmer has much more flexibility in writing or arranging his or her program. That is to say, a firmware programmer will require much less time to develop a firmware program for a specific application due to the flexibility and execution capabilities.

2. The extra cost of multi-tasking is minimum compared to the other solution.

It makes many applications feasible while the issue of low cost is also considered.

3. With the added control signals described in the last sections, the structure of Partial Twin becomes even more user-friendly, flexible and powerful.

The structure isn't complicated and the control block is simple but useful, so it's convenient for firmware programmers and hardware engineers to easily substitute a conventional microcontroller with one having the Partial-Twin structure in accordance with the present invention.

Although the present invention has been described in considerable detail with references to certain preferred versions thereof, other versions and variations are possible and contemplated. For example, more blocks can be duplicated other than the exemplary embodiment. Finally, those skilled in the art should appreciate that they can readily use the disclosed conception and specific embodiments as a basis for designing or modifying other structures for carrying out the same purpose of the present invention without departing from the spirit and scope of the present invention as defined by the appended claims.

What is claimed is:

1. A partial-twin microprocessor structure, comprising:
a first set of processing units comprising at least one processing unit, to be shared by at least two tasks running in parallel; and
a second set of processing units comprising at least one processing unit, to be dedicated to one task when running at least two tasks in parallel.

2. The partial-twin microprocessor structure according to claim 1, wherein said first set of processing units comprises a program memory, an instruction decoder, and an arithmetic logic unit (ALU).

3. The partial-twin microprocessor structure according to claim 1, wherein said second set of processing units comprises a plurality of program counters to store a plurality of program addresses.

4. The partial-twin microprocessor structure according to claim 3, further comprising a plurality of stack memories and stack pointers.

5. The partial-twin microprocessor structure according to claim 3, further comprising a stack memory and two stack pointers.

6. The partial-twin microprocessor structure according to claim 3, wherein said second set of processing units further comprises an address selection logic to output a program address to said first set of processing units.

7. The partial-twin microprocessor structure according to claim 6, wherein said address selection logic outputs a program address based on an address selection signal.

8. A task selection apparatus for a partial-twin microprocessor structure, comprising:
a plurality of program counters to store a plurality of program addresses; and
an address selection logic to output a program address.

9. The task selection apparatus for a partial-twin microprocessor structure according to claim 8, wherein said address selection logic is a multiplexer.

10. The task selection apparatus for a partial-twin microprocessor structure according to claim 8, wherein said address selection logic outputs a program address based on an address selection signal.

11. The task selection apparatus for a partial-twin microprocessor structure according to claim 8, further comprising an enable signal to turn on said address selection logic.

12. The task selection apparatus for a partial-twin microprocessor structure according to claim 11, further comprising a clock speed signal to select a clock speed.

13. A partial-twin microprocessor structure, comprising:
a first set of processing units comprising at least one processing unit, to be shared by at least two tasks running in parallel;
a plurality of program counters to store a plurality of program addresses for different tasks;
an address selection logic to output a program address to said first set of processing units; and
at least one stack memory.

14. The partial-twin microprocessor structure according to claim 13, wherein said first set of processing units comprise a program memory, an instruction decoder, and an arithmetic logic unit (ALU).

15. The partial-twin microprocessor structure according to claim 13, further comprising a plurality of status registers and accumulators.

16. The partial-twin microprocessor structure according to claim 13, wherein said address selection logic outputs a program address based on an address selection signal.

17. The partial-twin microprocessor structure according to claim 13, further comprising an enable signal to turn on said address selection logic.

18. The partial-twin microprocessor structure according to claim 13, further comprising a clock speed signal to select clock speed.

19. A method of executing multiple tasks in parallel, comprising:
providing a plurality of program addresses into a partial twin microprocessor;
selecting a program address to be inputted into a program memory; and
loading a program from said program memory.

20. The method of executing multiple tasks in parallel according to claim 19, wherein said selecting a program address is based on an address selection signal.

21. The method of executing multiple tasks in parallel according to claim 19, further comprising enabling the step of selecting a program address.

22. The method of executing multiple tasks in parallel according to claim 19, further comprising multiplying a clock speed.
